(19) United States
(12) Patent Application Publication
(10) Pub. No.: US 2012/0330572 A1
(43) Pub. Date: Dec. 27, 2012

(54) Cyclic Cranked System Method and Related Devices

(76) Inventor: David John Longman, Florea (AU)

(21) Appl. No.: 13/512,025

(22) PCT Filed: Nov. 26, 2010
(86) PCT No.: PCT/AU10/01594

§ 371 Date: Sep. 13, 2012

(30) Foreign Application Priority Data
Nov. 28, 2009 (AU) 2009905809
Sep. 21, 2010 (AU) 2010904245

(51) Int. Cl. G06F 17/40; G01L 3/00

(52) U.S. Cl. 702/44; 702/187

(57) ABSTRACT

A cyclic cranked system data gathering system has at least one crank arm (30,50,116,117) operable by a limb of a user, at least one data gathering device (112,113) each mounted to a respective crank arm (30,50,116,117) and having at least one respective sensor (140,141). The or each device is configured to obtain data relating to force applied by the user through the respective crank arm and sensed by the respective sensor, and has a data transmitter capable of sending said data to a remote data logger, remote computer or to a display device. A method of determining power applied to a cyclic cranked system includes using a device (112,113) mounted on a crank arm (30.50,116,117) of the cranked system to sense strain signals resulting from force applied to one or more crank arms by a user, determining power applied by the user from the strain data, and transmitting the strain data, modified or unmodified, to one or more of a display, a data logger, a computer or another similar device mounted on another crank arm of the cranked system.

### TECHNICAL FIELD

The present invention relates to a means for measuring the power input, power output, torque and/or force(s) exerted through a cyclic cranked system, such as for example, by a bicycle rider whilst riding a bicycle or a manually operated winch arrangement used in sailing.

The present invention also relates to the processes and methods used to provide useful output data in relation to the power input or output, torque and/or force(s) exerted by the user, as well as the packaging of devices, such as for bicycles and other manually operated cyclic cranked systems.

### BACKGROUND

A typical bicycle includes a pedal crank set having a pair of pedal crank arms and a pair of associated pedals, each pedal being rotatably mounted to a distal end of its respective crank arm. The efforts of a rider are translated to power though application of force to the pedals which provide a motive torque to a chain wheel or other transmission device which in turn powers a wheel or wheels of the bicycle.

“Power-meters” for bicycles are well known. Many different types of power-meters are available; examples including devices which measure and transform bicycle chain tension data into power readings, instrumented rear hub axles, instrumented chain-wheel devices, and instrumented crank axles and/or bottom brackets. A power-meter system normally has a force or torque sensing system that measures forces or torques applied by a bike rider (either directly or indirectly as explained further below), a transformation or processing means which takes signals or data from the sensing means and manipulates the data into parameters which are displayed on a display unit and/or stored in a memory unit for subsequent display and/or analysis.

One example of known prior art is given by United States patent publication US 2010/0093494 (also published by WIPO as PCT publication WO 2008/109914). A cartridge is arranged to be releasably retained in a hollow spindle of a bicycle axle. Sensor elements within the cartridge give signals corresponding to rotational angle of associated crank arms and/or torque applied thereto. The device measures pedaling forces through the spindle, and is designed for use specifically with a crankset described in corresponding US patent publication US 2007/0182122 by the same applicant rather than being configured for general use and adaptability. It has been realised that left and right hand sensors close to each other within the cartridge placed within the spindle may not provide accurate readings. Furthermore, no information is given about positioning sensors along the crank arms or how torque or power data might be obtain from such an arrangement.

Other examples of known power-meter systems include U.S. Pat. No. 4,463,433 and U.S. Pat. No. 5,027,303 which both describe a torque measuring system utilising strain gauges to measure the total torque input to a chain wheel by applying strain gauges to the pedal cranks, or to a chain wheel interface and a pedal crank. In one embodiment, as described in FIG. 7 of U.S. Pat. No. 5,027,303 (included here as FIG. 2), shows a pair of pedal cranks (ie left and right hand side cranks) with strain gauges laid on the upper and lower surfaces of the respective pedal arms. The pedal arms are of a rectangular or square cross-section and have a constant cross-section substantially throughout the length of the arm between the pedal and the axle. No detail is provided as to the determination of position or placement of the strain gauges on the surface of the pedal arms but it is understood that these stain gauges are purposely located about a central axis of the regular cross section pedal arm, are parallel to such central axis, and are positioned either side (ie bottom and top as viewed in FIG. 1) of the respective arm in a mirrored fashion. A neutral axis for forces which are applied transversely to such a pedal arm is readily understood to be at the geometric centre line on the top and bottom surface of such pedal arm. However, modern pedal crank arms have various shaped cross-sections and often sectional shapes which change along the length of the pedal arm. Furthermore it has become increasing common for pedal arms to have a recessed or hollow section, or be entirely hollow over a substantial portion of the pedal arm, for lightness and reduced amount of material whilst maintaining necessary strength. For such modern crank pedal arms which are not of simple rectangular or square constant cross-section, or which have limited surface areas at the top and bottom surfaces of the pedal arm, the application and use of strain gauges as primary sensors for a data gathering or power-meter system can be problematic. The location of the strain gauges is of primary importance as only the forces that produce motive power should be used for the calculation of power. Notably, the prior art does not provide any other details as to how such an arrangement, which places strain gauges on the other surface of the crank-arm, would be packaged to provide a low weight, robust and water-proofed system that allows ready access to data and convenience of use by the rider. It may be that some or all of the above shortcomings provide a reason that none of the prior art systems appear to have been released to the cycling market.

Modern use of non-symmetrical and/or non-constant cross-section crank arms and/or cranks arms with hollow sections, has presented difficulties in the use of strain-gauged crank arms due to the sensitivity of the strain gauges to “non-effective” forces that would otherwise result in erroneous data or power-meter readings. To explain further, bio-mechanists will often refer to “effective” and “non-effective” force application to the pedals of a bicycle: effective forces are those that are in the direction of rotation of the pedal crank (i.e. tangential forces to the pedal arm) and thus lead to the mechanical power input to the bicycle. Non-effective forces are all other forces that act upon the pedal cranks. Non-symmetrical shaped cranks, changing longitudinal cross-section and or hollow sections may increase the sensitivity of the stain gauges to non-effective forces and thus provide inaccurate readings of power input to the crank.

Non-effective forces and torques are generated in a number of ways. As the force applied to a pedal is offset from the longitudinal axis of the corresponding pedal arm, a torque will be generated about the longitudinal axis of the arm (indicted by the arrow Mx in FIG. 4). This torque will produce strains at the upper and lower surfaces of the pedal arm which, unless properly addressed, would result in strain readings which are not associated with an effective force. Non-effective forces may also be generated when a rider is out of the seated position and leans the bike from side to side whilst pedaling up a hill in a known pedaling technique. In this instance there will be an increased component of force lateral to the pedal arm (generally in the direction of the axis of the crank axle (ie along the Z axis as shown in FIG. 4).

It has become common practice for bicycle riders to have display units that are capable of receiving and displaying various parameters relating to the riding activity. Many of these display units have the capability to display a cycling effort related power output. However, there are drawbacks restricting a significant number of riders from adopting present power metering systems, for various reasons, including but not limited to the prohibitive cost and complexity of some of the available systems, or the fact that some of the systems impose a weight or other performance penalty on the bike rider and therefore would not be favoured for race related events and therefore make a purchase less likely.

Furthermore, some existing systems provide for the total power input to be measured: either by measuring at the rear wheel hub; by measuring input through a chain-ring interface; or by measuring chain tension. There is a useful compromise to be afforded to a user that desires an indicative power level at a lower purchase price by equipping a bicycle with and taking data readings from, only one pedal arm instrumented with the data acquisition and processing device described herein, which is contemplated within the scope of the present invention.

It is also recognised in the field of cycling biomechanics that the ability to track the torque output of each individual leg over a 360° crank rotation would be a valuable training tool. Currently available systems provide only the net resultant torque produced by the bike rider and do not provide data on the contribution of each leg. A negative torque contribution (ie the torque is in the opposite direction to the rotation of the pedal crank) is typically made by a leg on its upstroke, and if both legs are different in this regard, then, in the case that only net torque readings are available, it will appear the leg that is performing a down-stroke is producing less power than the other leg. This can therefore lead to the erroneous conclusion that it is the leg performing the down-stroke that requires additional strength training over and above the other leg, to improve its performance: this may actually exacerbate an underling unbalanced pedaling action and result in muscular or skeletal mal-treatment over the longer term. It will be appreciated that this concept is equally applicable to hand cranked systems where one arm or hand may be thought to require strengthening when it is actually the user that requires retraining to ensure that the other hand or arm is performing an efficient return stroke (equivalent to upstroke in pedal cycling).

### SUMMARY OF THE INVENTION

One or more forms of the present invention provides a cyclic cranked system data gathering device for mounting to at least one crank arm of the system.

The data gathering device may be a discrete unit for mounting within or to a crank arm, such as within a hollow crank arm or within an external recess in the crank arm.

The data gathering device may include signal receiving means, such as from one or more strain gauges, signal processing means, and a transmission means to transmit processed signal as data.

The data gathering device may incorporate one or more sensors, such as a strain gauge and/or temperature sensing means.

The data gathering device may be packaged as a discrete unit for mounting to or within a crank arm of the cranking system.

The data gathering system may include multiple discrete portions, such as first and second data gathering subsystems. A first data gathering subsystem may be mounted to or within a first crank arm and a second data gathering subsystem to or within a second crank arm of the cyclic crank system. One of the first or second data gathering subsystems may transfer or transmit data to the other subsystem, and vice versa.

The data gathering device may cooperate with another, non-crank arm, power information system, such as from a third party supplier. For example, known systems as described above derive power information from a rear wheel or axle or from the spider of the main front chain sprocket of a bicycle. A data gathering system of the present invention may obtain or derive data from such a non-crank arm type system and communicate both sets of data and/or process the third party system data to assist in deriving data relating to the other crank arm not fitted with its own subsystem. For example, information relating to signals from the first crank arm may essentially be subtracted from overall power, force and/or torque information derived from the non-crank arm type system to derive data values relating to the other, non-sensed, crank arm.

Each crank arm may be provided with a data gathering subsystem and/or a data gathering device, such as fitted by an original equipment manufacturer or as a retro fit or ‘after market’ product.

It is envisaged that, in the absence of the second or subsequent subsystem or if such a second or subsequent subsystem is inoperative (such as due to failure or lack of electrical power), the first subsystem may provide replacement data or information to compensate. For example, in an application of the present invention fitted to a bicycle, if a data gathering subsystem is fitted to only one crank arm, that subsystem may create data or duplicate its own data in place of data from what would be obtained from a second subsystem on the other crank arm. This arrangement is particularly efficacious where a receiving means, such as a remote display or computer, requires or expects to receive data relating to the total power input by the user. Even if two or more such subsystems are provided and working, it may be that a data signal from one to the other is not received by the first data gathering subsystem (e.g. due to interference or signal loss) and therefore the first data gathering subsystem can compensate by generating a replacement data set.

One or more strain gauges may be used to obtain signals representing power input, torque and/or force values from a crank arm. The strain gauge(s) may be positioned intermediate distal and proximal ends of the crank arm, such as between a pedal or handle at a distal end and an axle or other rotary pivot at the proximal end. It has been found beneficial to position one or more of the strain gauges towards the distal e.g. pedal end of the crank arm. Such positioning towards the distal end is counterintuitive to conventional thinking because there is greater load or strain at the proximal end (e.g. shaft or axle end) of the crank arm and therefore more easily measurable since a high strain reading will be present. However, the scope of the present invention includes positioning one or more strain gauges towards the proximal end of the crank arm to reduce the possibility of non-effective torques/forces being sensed. It has been found possible to determine desirable positioning for the strain gauge(s) at a certain location on the crank arm such that all or most of the non-effective torques/forces are either not present because of that carefully determined positioning or are so minimal as to not be resolved or not be significant.

As explained above, modern use of non-symmetrical and/or non-constant cross-section crank arms and/or cranks arms with hollow sections, may have prevented the use of strain-gauged crank arms due to the sensitivity of the strain gauges to “non-effective” forces which would otherwise result in erroneous data or power-meter readings. Embodiments of the present invention determine preferred positioning for strain gauges which ‘resolve out’ these unwanted forces and/or torques. For example, as a right hand pedal is forced down, a proportion of the downward force applied by the rider produces a torque about an axis through the length of the crank arm i.e. a torque that tries to ‘twist’ the crank arm along its length. This produces tension and compression zones within the crank arm, with a zone or line of zero strain separating these regions. Similarly, any sideways forces on the crank arm (e.g. perpendicular to the length of the crank arm) produce zones of tension and compression forces within the crank arm again with an intermediate zone or line of zero strain. Resolving where these zones or lines of zero strain for each of the different load applications coincide determines the positioning of the strain gauges within embodiments of the present invention. The exact position of coincidence will vary with each type, shape and structure of crank arm. These zero strain zones or lines can be determined, such as through finite element analysis (FEA) techniques, a comparison of the zones made to determine where the lines of zero strain lie within the crank arm, and the position for the strain gauge(s) selected based on the coincidence of the zones or lines. For increased accuracy, the analysis may simulate the area over which the strain gauges will be effective and calculate the signal which would be output from an actual strain gauge, In this way the effect of even small changes of the strain values either side of the zero line or zone can be properly accounted for in the output value of the strain gauge. The non-effective forces are not resolved by the strain gauge(s). Tangential forces (effective forces) having a non-coincident line of zero strain are still resolved by the strain gauge(s) resulting in useful and accurate power, torque and force signals for the data gathering device without erroneous signals from non-effective forces. The data gathering device can then send data to the output device (preferably by wireless communications), such as a display or computer, based only on effective forces. This is particularly effective for non regular cross section crank arms, hollow crank arms, crank arms that taper or change in shape and/or size of cross section, and crank arms that are different in shape, size and/or cross section for each arm or leg of a user. Unlike known arrangements, such as described in U.S. Pat. No. 4,483,433 and U.S. Pat. No. 5,027,303, embodiments of the present invention do not rely on a regular and/or solid cross section to the crank arm to position the strain gauge(s) and determine power.

The applicant has found that by applying modern and sophisticated analysis techniques, precise locations and orientations for strain gauges can be found that allow their use in pedal crank arms that are not of simple symmetrical and constant cross-sectioned geometric shapes—in contradistinction to prior art system. One actual analysis technique utilised by the applicant involves the steps of:
1. Creating or obtaining high resolution digital models of the crank arms;
2. Applying finite element analysis techniques to determine the strains resulting from each of the 3 primary mutually orthogonal forces and moments;
3. Applying post-processing techniques to the strain data output from the FEA analysis to simulate actual strain gauge data output (such simulation including the actual foot print area, location and orientation of strain gauges) so as to simulate the output of actual strain gauges connected to a electronic Wheatstone bridge—discussed further hereinbelow). This post processing will provide unique locations for placement of strain gauges that will result in output of a Wheatstone bridge which incorporates those strain gauges only responsive to effective forces.

Furthermore, the present invention does not need to rely on additional elements introduced within the force transmission path from pedals to wheel (eg requiring intermediate parts where the stain gauges are located.)

Embodiments of the present invention may provide a discrete or self-contained insert to a crank arm through which the torque is transmitted.

Strain gauges are preferably positioned in pairs, such as on opposite faces (top and bottom) of the crank arm. Pairs may be mirrored one directly opposite the other.

Unique calibration techniques have been developed to be applicable with one or more embodiments of the present invention. One such technique particularly applicable to bicycles includes raising the rear wheel of the bicycle, spinning that wheel in reverse which rotates the crankset and pedals backwards, a reading of the data from the sensors taken at this time represent a zero load and is stored in memory as a zero load offset (bearing in mind that strain gauges produce a signal at all times).

Separating antenna and processing sections in the data gathering device has been found to assist in ensuring integrity of data transfer. Positioning the antenna towards the distal end (e.g. pedal end) of the crank has also been found to be beneficial in ensuring reliable transfer of data from the data gathering device to a remote read out, display or data processing device, or to a paired data gathering device on the opposite side of the crank set. Whilst the location of a communication antenna may be identically positioned within or on a respective left and right crank-arm, trials by the applicant have also shown that there may be some benefits in using different locations of the antenna in the left and right crank arms. For instance, the location of the antenna in the right hand crank arm (normally associated with the chain ring drives for a bicycle) may be towards a proximal end of the crank arm and located such that the antenna is not as obscured by the chain-rings in relation to a line of sight to the antenna in the left side crank, which may be more towards a distal position along the arm.

Crank angle position data may also be obtained, either by the data gathering device or by an additional means, such as a separate sensor means e.g. a reed switch crank angle position sensor or a (inductive) coil pickup passing a magnet. Other types of sensors are envisaged to be suitable. In the case of a coil pickup, the coil pickup may also serve the purpose of powering the data gathering device and associated wireless communication systems. Advantageously the cadence/crank angle sensor may be placed at a distal end of the crank arm that provides improved angular resolution and/or higher flux cutting speeds in the case of coil and magnet systems.

For some applications, for example the stationary or gym bike market (which often have unique frame designs and therefore may not have convenient locations for placing cadence magnets) the use of gyro's or accelerometers to provide angular rotation and/or cadence data can be particular useful.

The present invention may include embodiments that incorporate processors and circuitry that perform fast-Fourier-transformations (FFT) on sensed strain gauge data and communicate a selected number of terms of the FFT to a display unit. This provides an efficient method of communicating crank-angle based power and/or torque data to a display unit or to a memory unit. These data may then be “unpacked” to provide detailed analysis of the pedaling action of a rider.

The present invention may include embodiments that compensate for temperature. Thus, the data gathering device may obtain or be provided with values relating to temperature of one or more crank arms and/or temperature fluctuations affecting the system. Temperature values may be utilised to modify, calibrate and/or maintain accuracy of signals or data into or out of the data gathering device or may be used with the data set transmitted from the data gathering device. More specifically, the present invention contemplates calibration values which take into account any temperature related changes of the sensors and/or the base material of the crank arms to which the sensors are applied. In this way not only will the calibration account for strain values which are generated as a result of temperature changes but also will account for how these strain values changes when the base material of the crank is at different temperatures (e.g. changes to the Young's modulus of the base material).

Each crank arm and/or data gathering device may be nominated to have a unique identifier. A paired set of crank arms each equipped with respective data gathering devices may have identical identifier numbers except for a single digit (or bit if in binary form). This last part may be an even number (or “0” in binary) and an odd number (or “1” in binary) for each of the pair respectively. By pairing the devices in this way, any other signals coming from other devices may be screened out. Each device transmits power related data to the other device, together with its identifier number. If one device receives recognised power related information from the other, then it adds this to its own power related information and transmits this through another channel for receipt by a display or other device. This is particularly useful in the case that a display device can only receive a single input of power related data (as is the case with many existing display units). In such a case, the above described communication protocol ensures that if only a single crank arm subsystem is used, this subsystem will recognise that the other crank arm subsystem is not present and may take account of this by doubling the power output value of the single crank arm subsystem and may provide this data to the display unit. Rather than a doubling of the power output value another factor may be used in the case that a known (or calibrated) difference in user left to right cranking actions exists—for example a rider may reliably know or be able to derive (from testing procedures) that on average his left leg produces only 95% of the power of his right leg. If a data gathering device is installed only on the left hand crank, then the calibration factor used for power data issued to a display unit would be 2.053 (that is 195 dived by 95). The opposite is also envisaged where the data gathering device is fitted only to the right hand crank arm.

It is to be understood that although particular forms of the present invention will be described in the context of a leg powered bicycle, the present invention may equally be applied to any manually (human or other animal) powered device which uses a cyclic cranking action (either legs or arms or legs and arms) to power a device or apparatus whether stationary or moving. The invention is particularly useful as a training aid for bicycle riders using either static or mobile bicycles.

It will be appreciated that the present invention may incorporate the following features: The system may register low or zero power with cadence (cycling rhythm)—such as may occur when going down a hill and continuing to pedal but without providing any real effort in powering the bicycle) and calculates centrifugal forces due to the rider's legs/shoes or, for a hand operated cranked device, the user's hand/arms etc. This data can be used to subtract centrifugal forces from measured radial force. The remaining radial force is typically referred to as non-effective force. Knowledge of this force (on a crank angle basis) is a useful training aid; the system may also be placed in a mode wherein the weight of the rider can be directly assessed. In this case the rider would stand on the pedals whilst balancing ideally with minimal horizontal support against a wall or handrail in such a way that all of the riders weight was effectively placed on the pedals (horizontal support to prevent the rider falling over does not affect the vertical forces required for weighing purposes). This “weighing” application can be particularly useful as an input in various training techniques as a “per kilogram” basis is often a relevant parameter for cyclist (e.g. watts per kilogram (Wkg⁻¹) is a well known parameter for cycling ability).

Additional strain gauges may be provided or change the outputs of the circuitry, such as the Wheatstone bridge circuitry, may be varied to be able to determine certain non-effective forces or torques. This may provide useful data to distinguish isotonic versus isometric forces.

Embodiments of the present invention may include onboard power generation. For example, use of same magnet that provides cadence data to power a coil or inductive pickup or sensor. Further aspects of this arrangement are discussed further herein below.

Preferably an electrical coil is disposed towards a distal end of the crank arm thus ensuring a high flux cutting speed for electrical power generation and/or an increased angular resolution for a cadence signal. Furthermore, in the case of a charging coil it is preferable that a magnet arrangement be used in which a north pole and a south pole are closely spaced such that a high rate of flux change is experience by the coil as it passes the magnets. This also may further enhance the resolution of the angular position of crank as it passes the magnets.

Additional crank angle position inputs or encoders may be utilised to give increased resolution to crank-angle position and cadence sensing and/or for on-board power generation. For example a gyroscopic sensor (commonly referred to as a “gyro”) may be included in the system (most conveniently mounted on the same board as the other electronic components of the system). Such gyro may be used to provide additional rotational data which may provide additional resolution of angular position, velocity and/or acceleration.

The present invention also contemplates that cadence and/or crank position data be exchanged between a left and right crank arm and that the data processing system of a crank arm uses the additional data available from the other crank-arm to enhance the accuracy or resolution of the angular position, velocity or acceleration of the first mentioned crank-arm.

Forms of the present invention may incorporate automatic start and/or stop control for the system.

It will be appreciated that the data gathering device receives force related signals from one or more strain gauges, and preferably from one or more cadence sensors/encoders, and may process those signals onboard or may transmit those signals (processed, part processed or unprocessed and by wireless and/or wired connection) to a remote display and/or processing device, such as a computer.

Preferably such signal and data are issued wirelessly.

For the purposes of the present invention, signals received from sensors, such as strain gauges and cadence encoders, are considered data.

The data gathering device may form part of a broader system utilising one or more modules, each module being mounted into or on a crank arm of a cyclic cranking system. Each of the modules may be a data gathering device or may be multiple data gathering subsystems, such as individual data gathering modules each for a separate crank arm. The individual data gathering modules may communicate from one to other and/or vice versa, and for communicate with an additional remote device such as a computer or display. A remote computer or display may be used to determine or show user telemetry, such as power information, cadence, left-right leg/arm power, force and torque information, speed, pedaling force balance etc.

One or more of the data gathering devices/modules may include or be able to determine global positioning information (such as by GPS) and/or may include user or vehicle (such as a bicycle or watercraft) balance or orientation information. Alternatively, such position, balance and/or orientation information may be provided via a remote source.

The or each device or module may include one or more additional sensors, such as accelerometers or gyro's to give rate of change of velocity data, which can be used to verify or combine with force data from the strain gauge(s).

Crank arms, particularly in modern cyclic devices, such as bicycle crank sets as described above, can be hollow or have one or more recesses. A device or module of the present invention can be mounted into the hollow or recess, adding minimal weight (typically of just a few grams). Electrical connection is then herein are eminently suitable for application to such systems as a means to sense the input being made by the rider. Bi-lateral pedal arm or single crank arm (pedal arm) inputs could be utilised in such cases, and the auxiliary power may be input as a function of the amount of power being provided by physical exertion of the user.

It has been found preferable that the force sensor of a crank arm directly connected to a chain ring of a cycle chain is not provided in the same region as the large chain ring radius i.e. the force sensor should not be at or adjacent the toothed periphery of the chain ring, as this is where damage could occur.

Calibration

A further form of the present invention provides a method of calibrating a cyclic cranked system data gathering device, the method including:
a. determining an output value of the device at ambient temperature without a given load applied;
b. determining an output value of the device at ambient temperature with the given load applied;
c. determining an output value of the device at a known elevated temperature without a given load applied;
d. determining an output value of the device at the known elevated temperature with the given load applied; and
e. setting the device to give a temperature compensated output based on the values determined at steps a to d.

Temperature variations have a dramatic affect on the reliability of readings on a display receiving its input from a cyclic cranked system data gathering device, such as a cycle power meter. As temperature rises, materials typically get less stiff, such as the crank arm of a cycle crank set to which the device may be mounted. Consequently, errors in readings can occur. Whilst readings may be correct at the start of cycling, a rise or drop in temperature can give readings with significant errors after a period. Thus, important information about user (rider) performance is lost or incorrect. This can lead to incorrect training regimes, incorrect comparison of data between users or with a user's own previous data. Having an improved calibration technique helps to ensure that

Inductive Charging

According to a further form of the present invention, there is provided an inductively powered cranked system data gathering device.

A further form of the present invention provides a cranked system data gathering device power system including inductive charging means remote from the device, and inductive power means connected to or within the device, the inductive charging means providing an electrical source to the inductive power means to power or charge the device.

The inductive charging means may be a discrete unit, such as a charging pack either mains powered or itself including electrical charge storage and means to inductively charge the device.

The cyclic cranked system data gathering device may be battery powered. The battery may be charged inductively, such as by applying the inductive charging unit to or adjacent to the cyclic cranked system data gathering device. Thus, for a battery powered inductive charging unit, the unit may be transportable and used to charge one or more cyclic cranked system data gathering devices ‘in the field’. This can be very, useful if a cyclic cranked system data gathering device loses sufficient power or has insufficient power before, during or after use. The device can be recharged without needing to return the cycle to a ‘home’ or mains power location.

Alternatively, a coil and magnet arrangement can be used on the cycle. Preferably a moving coil and fixed magnet, may be utilized. For example, the magnet may be mounted to a frame of the cycle. A coil may be mounted on part of the rotating crank set, such as on a crank arm, front chain-ring or guard, or a pedal. Preferably the moving coil is positioned such that it passes the magnet as close as practically possible in order to ensure that the coil passes through the maximum magnetic flux and thereby produce as much power as possible to power the device and/or charge the battery. Advantageously one or more closely spaced north and south pole facing magnets are utilized.

Inductive charging of the cyclic cranked system data gathering device removes issues of waterproofing the device. Having a charging plug or socket arrangement on the device, or having a compartment that is openable for removing the battery or otherwise charging the device, increases the risk of data obtained from the cyclic cranked system data gathering device is correct within a reasonable temperature range.

For example, at the start of riding, zero is set at a given ambient temperature. As a ride progresses, the ambient temperature may increase or decrease, or fluctuate up and down during the ride. Unless the cyclic cranked system data gathering device is able to compensate for temperature change(s) by having been calibrated beforehand, such that zero across a range of temperatures is known and an output signal to a display is compensated to give a correct value (eg a rider input power value), erroneous values could be given.

Calibration may include further steps of determining an output value of the device at below ambient temperature without the given load applied and determining an output value of the device at below ambient temperature with the given load applied. This can enhance accuracy of the output signal to a display or other device because calibration is carried out across a broader range of temperatures.

Calibration may be carried out with the device mounted in position on a cycle crank arm. This increases accuracy. Preferably calibration is carried out in a temperature controlled environment, such as a temperature controlled room, box or cabinet, wherein the temperature can be elevated above ambient or lowered below ambient, and/or used to set a preferred ambient temperature prior to elevating or lowering the temperature relative thereto. Thus, calibration can be set for expected environments, such as generally warmer or cooler countries or locations.

Side on wind-chill effects in wet conditions can be a problem for obtaining accurate readings from a cyclic cranked system data gathering device mounted to each crank arm of a crank set of a cycle because readings from opposite sides (windward and leeward) can give rise to false readings due to the temperature differences in the materials on either side of the cycle. Calibration according to one or more embodiments of the present invention alleviates or removes this problem.

made between the one or more strain gauges attached to the crank arm. Each strain gauge may be mounted during manufacture of the crank arm or may be retro-fitted. Circuit boards incorporating A-D converters and/or processing and wireless communication capability may preferably be of an elongate form, and having a width less than the width of an associated crank arm to which they will be attached. This elongate form provides packaging advantages in that the circuit board may be placed in a region behind the crank arm (the reference to “behind” being to that side or face (e.g. the “inner face” facing the chain ring) of the crank arm that faces the bike) and thereby be afforded a significant degree of protection form impact with foreign objects. The elongate form also provides the advantage that the distance between an antenna of a wireless communication system, that may be located on such board, and other circuitry that may cause interference can be maximised.

Although the present invention contemplates that the strain gauges may be placed on an internal surface of a crank arm, the present invention is particularly suitable for application wherein the strain gauges are applied to the outer surface of a crank arm. This not only ensures that the gauges are placed in a region of relatively high strain, but also that there is considerably more design freedom for the crank-arm design in that designs are not required to deviate drastically from currently well understood and preferred designs.

Crank arms may be provided as matched pairs, preferably each with unique identifiers (e.g. code numbers). Alternatively, just the modules or devices may be uniquely matched so that they ‘talk’ to each other.

Data encryption may be provided when communicating data between devices or modules and/or when communicating data to a remote device. This can avoid unauthorised access to data, such as by third parties in racing teams or training groups.

In certain electric powered bicycles it is desirable that the user maintain an amount of physical power input. This may be as a requirement of licensing regulations or as a choice by the user to maintain and enhance a level of fitness whereby the electric propulsion system provides auxiliary power input to supplement the efforts of the user. It will be apparent to the skilled address that the data gathering devices/systems, such as power meter devices, described ingress of water and/or dirt. Consequently, inductive charging capability, which does not require openable access to the device, reduces the risk of problems. Charging can therefore be either automatic when cycling or a matter of mounting the charger close to the device. In the case of automatic charging (charging whilst cycling), the user would never need to recharge the battery themselves. In fact, power control within the device can be arranged such that a battery need not be required. In which case, capacitor or other storage of charge can be utilized.

Preferably each crank of a bilateral system is completely self contained and includes its own inductive charging coil.

An induction coil may be positioned at a relatively large radius from the crank axis as this positioning can ensure a relatively high velocity as the coil passes the stationary magnet (most conveniently placed on the chain-stay of the bike frame). Preferably the coil is placed towards or at an end of a crank arm distal from the crank, or on the front chain set or chainguard that rotates with the chain set. This assists with creating a stronger induced current.

If the inductive charging unit is left mounted to the cycle, an audible and/or visual alarm may be given if the cycle is moved or attempted to be used. This prevents the user riding off with the cycle before charging is complete or with the charging unit in place which might otherwise be damaged or lost.

Preferably the charging unit may be brightly coloured as a visual indication it is in use or present on the cycle.

According to one or more alternative embodiments, a contact charging unit may be used. For example, one or more electrical contact points or connectors may be provided to supply electrical charge to the device. This may be by contact or by connection between electrical connectors on the charging unit and corresponding connectors for the device. Such connectors on the device may have a removable cover. Power may be supplied to charge the battery/batteries via a “plug in” external power supply, such as a DC jack with a transformer pack. For example, the device may have an associated electrical socket arranged to receive a jack plug connected to a transformer pack. The transformer pack may plug in to an electrical supply, such as a mains electrical socket.

Charging means may be provided remote from data gathering device(s), and power means may be connected to or within the device, the charging means providing an electrical source to the power means (which may be an inductive power means) to power or charge the device(s) by physical contact to convey electrical charge to the device. Alternatively, metal to metal electrical contact need not be provided. Contactless (inductive) charging may be provided by inductive charging means being, mounted to or adjacent the or each device.

The or each device mounted to a respective crank arm may be independently powered, such as by inductive charging e.g. from a coil cutting a magnetic field of a magnet. Either the coil or the magnet could be stationary, such as mounted to a frame of a cycle, and the other of the coil or magnet mounted for motion relative thereto, such as on a crank arm or chain wheel of a cycle. Thus, there need not be wired connections between the crank arms.

Packaging

A pair of cranked system data gathering devices according to one or more embodiments of the present invention may be used, one on each crank arm of a cycle. Each may obtain data and send the data to a display or other receiver. Alternatively, one may send data to the other for combining with data before transmitting to the display or receiver, or simply relaying to the display or receiver, such as a master and slave arrangement.

Each device may include an antenna for transmitting data. Antennae can be offset relative to one another. For example, because the crank arms of a cycle are moving when in use, there is not always a direct line of sight between those arms and/or a display unit. Parts of the frame tubing interpose between the two at different rotational angles. Also, a signal may have to travel through the central crank and bearing arrangement, especially if the devices are mounted equi-distant along their respective crank arms.

The antenna associated with the crank arm attached to the chain rings may preferably be provided inside the radius of the smallest radius chain ring. The antenna in each of the respective crank arms may also be offset in different directions with respect to the longitudinal axis of the crank-arm, thus providing further asymmetry of the antenna position and improving the line-of-sight between those antenna.

A particularly advantageous location of the antenna for wireless communication has been identified. The Preferably the antenna may be located such that it is:
a) above the bottom of a cavity in a crank arm in which the antenna is housed (i.e. the antenna is raised off the bottom surface of the cavity; and/or
(b) raised slightly proud of the sides of the cavity in a crank arm in which the antenna is housed (i.e. looking from a side view across the crank arm or end view along the crank arm, the antenna can be seen projecting or entirely above the envelope of the crank-arm.

The left hand crank of a typical cycle, such as a bicycle, has relatively good line of sight for communication with a display or other receiver at the handlebars. The front chainset on the right hand side reduces line of sight from the right hand crank arm to the handlebars and reduces line of sight across the cycle between the left and right hand crank arms. It has therefore been found beneficial to position an antenna for a right hand cyclic cranked system data gathering device (such as on or in the right hand crank arm) at a location that is more proximal to the axle (as compared to the corresponding left hand crank system) and at a smaller radius than a corresponding chain-ring. This positioning increases line of sight opportunities to an antenna of a corresponding cyclic cranked system data gathering device or relay device on or in the left hand crank arm. In this way, the right hand cyclic cranked system data gathering device can relay data signals to the left hand cyclic cranked system data gathering device via the offset antennae. The left hand cyclic cranked system data gathering device can then relay the right hand signal unprocessed to the display or other receiver, or bundle/combine that data with its own gathered data (left hand crank arm data) before sending to the display or receiver.

Such an arrangement reduces the likelihood of data loss from the right hand cyclic cranked system data gathering device, and therefore increases reliability of receipt of data and ultimately usefulness of the final data.

Data signals may be transmitted through the crank axis, such as wirelessly through a hollow crank. In such an arrangement, at least one of the devices may include a transmitter with an antenna positioned at or close to the crank axis. Another said device may then include an antenna positioned at or adjacent an opposite end of the crank axis, the crank axis being within a hollow crank, for receiving transmitted data from one device to the other. Both devices may be configured to transmit and receive data through the hollow crank axis via their respective antennae.

One or more antennae may be used to relay the signal between left and right cyclic cranked system data gathering devices.

By avoiding any wired connection between the respective crank arms improved robustness and waterproofing can be achieved. It also allows for simplified installation of one or more of the cranked systems by a owner or a service technician.

The sensor(s) associated with a crank arm may include one or more strain gauges mounted on the respective crank arm. The device may include a signal or data processor, and a data transmission means, mounted in the device on or within a cavity of the respective crank arm.

The position of the sensor(s) on a corresponding crank arm may be determined by finite element analysis (FEA). For example, FEA may determine strain actually measured by a sensor mounted in a selected location on the crank-arm, such location resulting in a zero output from a data processor for all forces and torques applied by a user to the crank arm except those forces which result in a mechanical power input to the rotating crank.

The sensor(s) (e.g. strain gauges) may be mounted to a crank-arm which is not a symmetrical shape in cross-section. Alternatively, sensors or strain gauges may be mounted to a crank-arm which is not of a constant cross-section along its length.

A strain gauge ‘rosette’ may be used wherein two or more strain gauges are combined into a single strain gauge leaf and wherein the strain gauges are arranged orthogonal to each other in each leaf.

Data Logging

One or more forms of the present invention may include a data logging facility. For example, data signals from one or more cyclic cranked system data gathering devices may be logged, either preprocessed, unprocessed, or processed by a processor, within a data logger.

The data logger may include a capsule or container for a data memory device. Connection means may be provided to electrically or optically connect to the data memory device. For example, a USB connection may be provided. Physical connection to the data logger for electrical transfer of data may be protected by a removable cover. A screw or bayonet cap may be provided for an electrical connection point, such as a socket eg USB socket. Water resistance or waterproofing means may be provided to releasably seal the cover to protect the connection or socket.

In use, the data logger records data received from one or more of the cyclic cranked system data gathering devices. A remote device, such as a portable memory device (thumb drive or memory stick), or computer connection, can be connected to the data logger. Stored data can thereby be accessed, read, retrieved and/or used for review and/or archiving.

The data logger may be provided as a discrete unit mounted to a frame or other portion of the cycle or may be built in to the tubing of the frame during assembly. Data transfer need not be by physical connection. Radio frequency (RF), infra red or other wireless communication modality may be used. The data logger may therefore be a sealed unit, and may be powered, such as from its own battery supply, from the cyclic cranked system data gathering device, or may be supplied with power by the device to which it is connected during data retrieval, such as through a USB connection).

The stored data may be raw data from the cyclic cranked system data gathering device(s) that a display cannot otherwise interpret or display. Such raw data may be used for later analysis of a rider's pedaling characteristics (such as left right power balance) etc.

Indications

Many riders do not have sufficient time to read a visual display mounted to the handlebars of a cycle. Professional or serious riders undergoing training may be coached to meet certain performance criteria. These may include meeting set targets/limits, or remaining under such targets/limits. It has been realized that it would be beneficial to provide a rider with one or more audible and/or vibration indications when certain thresholds or limits are met. For example, a rider may wear an indication device that can give audible and/or vibration indications when certain limits are met. Limits may be cadence rate, speed, left right power balance through the pedals/crank arms, total power supplied by the user etc. The indication device may be part of a headset or other headgear, an earpiece or may include a transducer to provide vibration indications to the rider's skin, such as a glove or glove attachment. A rider may then modify their riding style to either exceed, meet or be under the required limits, as required.

For example, if a rider is not meeting a certain limit or taget, an audible signal may be given to the rider. At least one embodiment envisages giving a variable signal, such as increasing/decreasing signal pitch and/or frequency depending on how close or far the rider is from the limit.

Such audible/vibration indications can be transmitted from the display or other receiver or may come direct from a cyclic cranked system data gathering device.

Sealed Unit

According to one or more forms of the present invention, a cyclic cranked system data gathering device may be hermetically sealed to or within a portion of a crank arm for a cycle. Hermetic sealing may be formed by coating or covering the device with a waterproof layer, such as a polymeric material eg polyethylene.

The coating or covering may be a pre-moulded protector (such as a protective ‘jacket’) or may be a plastic coating applied over the device one mounted onto or in the crank arm.

Preferably the device may be charged through the coating or covering, such as by a remote charger unit described above.

Thus, a crank arm could be supplied with a cyclic cranked system data gathering device ready connected to the crank arm and hermetically sealed against ingress of dirt and water for reliability and avoidance of damage. The crank arm and cyclic cranked system data gathering device could thus be a fit and forget one piece unit.

Method of Use

Another aspect of the present invention provides a method of determining power applied to a cyclic cranked system, the method including;
using a device mounted on a crank arm of the cranked system to sense strain signals resulting from force applied to one or more crank arms by a user;
determining power applied by the user from the strain data;
transmitting the strain data, modified or unmodified, to one or more of a display, a data logger, a computer or another similar device mounted on another crank arm of the cranked system.

The abovementioned method may further include detecting if data has not been received from one of the devices, and if such data has not been received, sending a modified data sot to an external data logger, computer and/or display unit.

Doubling, recreating or repeating the value or amount of data determined by the device in order to compensate for the missing data from the other device, and sending the resulting compensated data to the data logger, computer and/or display unit avoids issues with loss of data. One or more sample readings may be taken using the sensors, the one or more sample readings relating to effort exerted by the user, the method further including processing this data obtained and sending data values to a data logger, computer and/or display unit or head-unit.

### BRIEF DESCRIPTION OF THE DRAWINGS

The present invention may be more fully understood from the following description of preferred embodiments thereof made with reference to the accompanying drawings in which:

FIG. 1 shows a bicycle incorporating a first embodiment of the present invention

FIG. 2 shows a prior art arrangement of strain gauges for measuring strain of pedal arms

FIG. 3 shows a partial cross-sectional view of a right hand side pedal arm.

FIG. 4 shows a left hand side of a pedal arm of the first embodiment of the present invention with reference axes marked.

FIG. 5a shows output scans of numerical analysis of a right hand side pedal arm with loads applied in the Z axis direction (as described in FIG. 4).

FIG. 5b shows output scans of numerical analysis of the pedal arm as shown in FIG. 5a when a torque is applied about the X axis (ie (Mx as described in FIG. 4).

FIG. 6 is an exaggerated displacement isometric view of the pedal arm shown in FIG. 5a, showing the distortion of the pedal arm under the influence of a torque about the X axis.

FIG. 7 shows a front view of a right hand side pedal arm assembly of a second embodiment of the present invention with the location and orientation of the strain gauges shown.

FIG. 8a shows a view of the upper face of a left hand side pedal arm assembly of a third embodiment of the present invention with the location and orientation of the strain gauges shown.

FIG. 8b shows a front side view of the pedal arm of FIG. 8a.

FIG. 8c shows a view of a lower face of the pedal arm of FIG. 8a.

FIG. 9 shows a Wheatstone bridge circuit schematic applicable to embodiments of the present invention, such as shown in FIG. 7.

FIG. 10 shows a partial assembled view of a crank set of the first embodiment as applied to a bicycle

FIG. 11 shows a cross-sectioned view of the left hand crank arm of the first embodiment.

FIG. 12 shows a view from the rear of the partial assembled crank set of a first embodiment per FIG. 10

FIG. 13 shows a further view of the crank set of FIG. 10, with the right hand side crank arm an chain wheel removed to show further packaging details of the power-meter device according to an embodiment of the present invention.

FIG. 14 shows a radar plot of power output data provided from a data acquisition and processing device of a first embodiment of the present invention as applied to a left pedal crank and a right pedal crank.

FIG. 15 shows the bicycle as shown in FIG. 1 but including a data logger attached to the cycle frame according to an embodiment of the present invention.

FIG. 16 shows an alternative antenna arrangement according to a further embodiment of the present invention.

FIG. 17 shows an exploded view of an embodiment of the present invention with a data gathering device to be recessed into a cavity in an inner face of a crank arm and an associated protective covering.

FIGS. 18A and 18B show an alternative application of the data gathering device set into a recess in a crank arm and with an antenna for sending and receiving data signals exposed outside of an envelope of the crank arm (shown without the protective cover in place.)

### PARTICULAR DESCRIPTION

One or more embodiments of the present invention will now be described with reference to the accompanying figures. However, the generality of the present invention is not to be taken to be limited to the embodiments and/or figures.

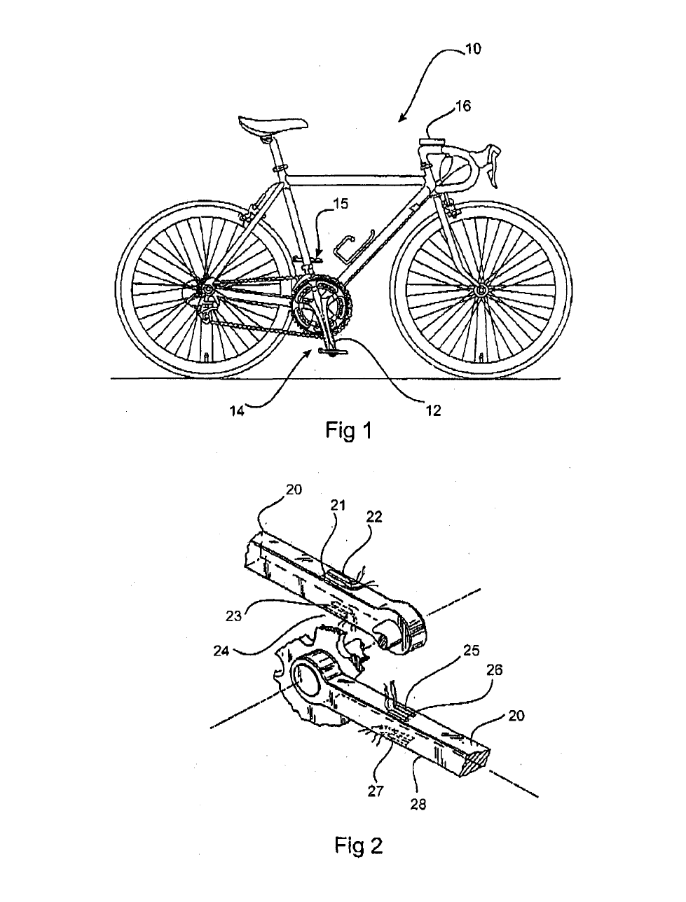

FIG. 1 shows a bicycle 10 incorporating a first embodiment of the present invention. The data gathering device 12 is mounted into one or more of the pedal cranks 14,15 and which communicates power, torque, force, crank angle, speed, position, balance and/or pedal acceleration data with a user display 16 which is mounted to the handlebars. It is notable that the device or each module of an embodiment of the present invention is discretely packaged so as not to impact on visual, functional (especially in terms of ultra low weight) or aerodynamic features of the bicycle.

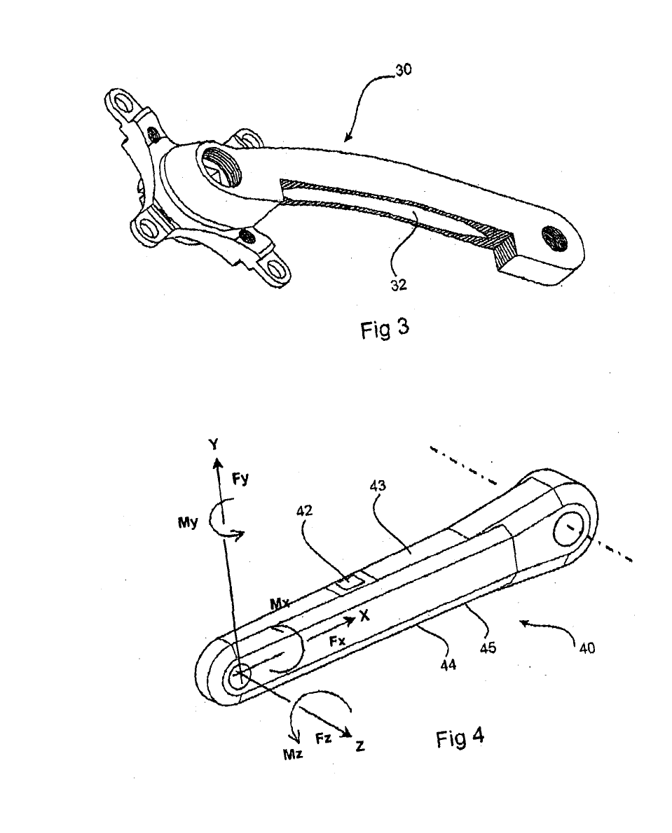

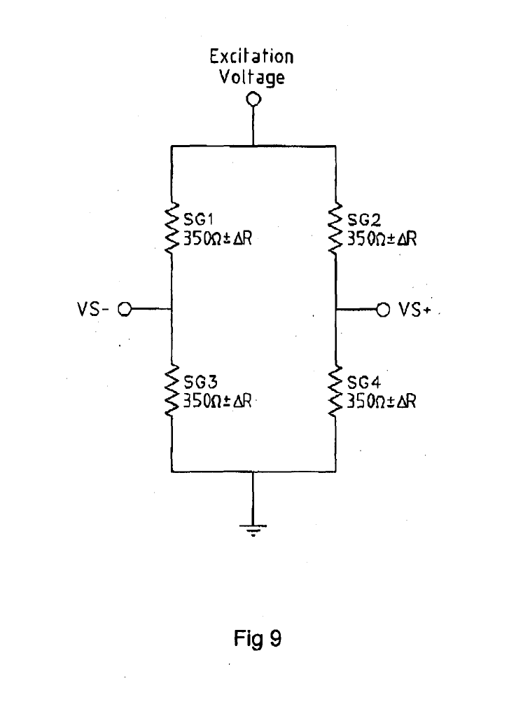

FIG. 2 shows a known arrangement of strain gauges 21, 22, 23, 24 for measuring, strain of pedal (crank) arms, 20. The strain gauges are mounted parallel to the length of the pedal arm and either side of a centre line. The pedal arm, 20, is of regular (rectangular or square) cross section along substantially the full length of the pedal arm. That is, the pedal arm, 20, does not vary in cross sectional shape. By orientating strain gauges (21 . . . 28) longitudinally, and about a central axis, such strain gauges may be used to determine the tangential force being applied to the pedal arms, 20. Forces and torques applied in other directions will cause strain, but as a direct result of the symmetrical and constant cross-section of such pedal arms, 20, the output from the circuitry (similar to that shown in FIG. 9) to which the strain gauges are applied will be small as compared to the output due to tangential forces.

FIG. 3 shows a partial cross-sectional view of a right hand side pedal arm 30. The pedal arm notably has a changing cross-section along its length and therefore does not lend itself to the use of strain gauges in accordance with the prior art. This pedal arm has a hollow centre section, 32, within which a device or module of the present invention may be fitted. Connection to one or more strain gauges (not shown) may be through the material of the upper, lower or side walls of the pedal arm. Alternative styles of pedal arm may have an external recess rather than an internal hollow portion. The present invention is advantageously applicable to either style.

FIG. 4 shows a left hand side of a pedal arm, 40, of a first embodiment of the present invention with reference axes marked. A strain gauge set, 42, (more details of which are described herein below) is shown mounted to the upper surface, 43 (in this view) of the pedal arm, 40, with a further strain gauge set 44, mounted on the lower surface, 45, on the opposite side of the pedal arm 40. Torque about the X axis i.e. identified as Mₓ caused by downward/upward force on the pedal (not shown) results in compression-tension forces along the pedal arm because the proximal end (crank end) of the pedal arm is essentially fixed and the pedal arm acts as a cantilever. Likewise, sideways forces (in the Z direction) also set up compression-tension forces in the pedal arm. It is noted that the use of pedal with bearings will result in zero or minimal torques being generated about the Z axis (ie Mz=0 or is negligible).

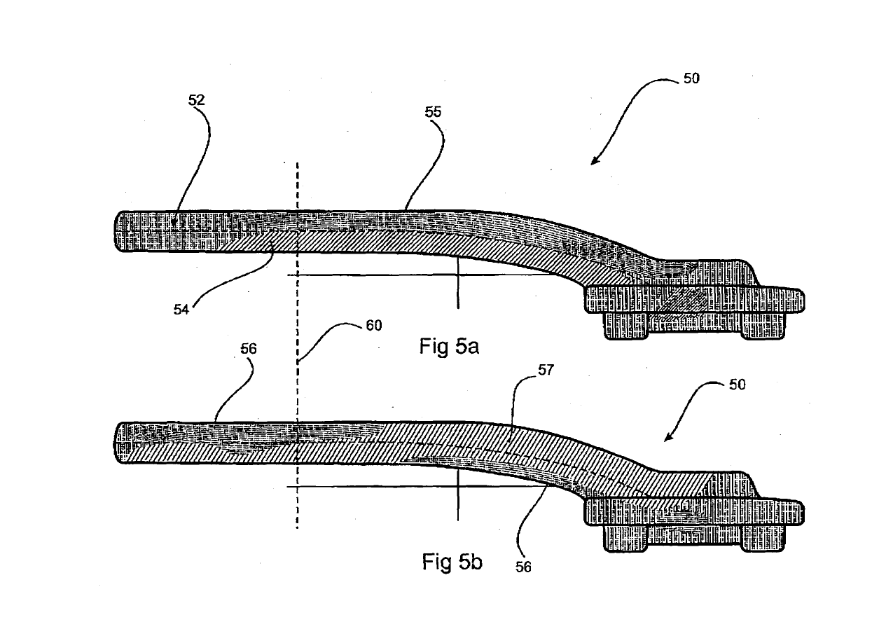

FIG. 5a shows output scans of numerical analysis of a right hand side pedal arm, 50 with loads applied in the Z axis direction (as shown in FIG. 4). The pedal would be mounted at the left hand (distal end) and the pedal crankshaft at the right hand (proximal end) in this figure. A line, 52, of zero strain in the x-direction (per FIG. 4) (no compression, no tension) is shown extending generally along a centerline of the pedal crank, 50. The lower side of the pedal arm in this figure depicts a zone 54 of compressive strain and the upper side depicts a zone 55 of tensile strain (conveying a sideways force on the pedal arm acting downwards in this figure). These strains are related to the stresses that cause them which are in turn related to the forces and torques applied to the pedal arm.

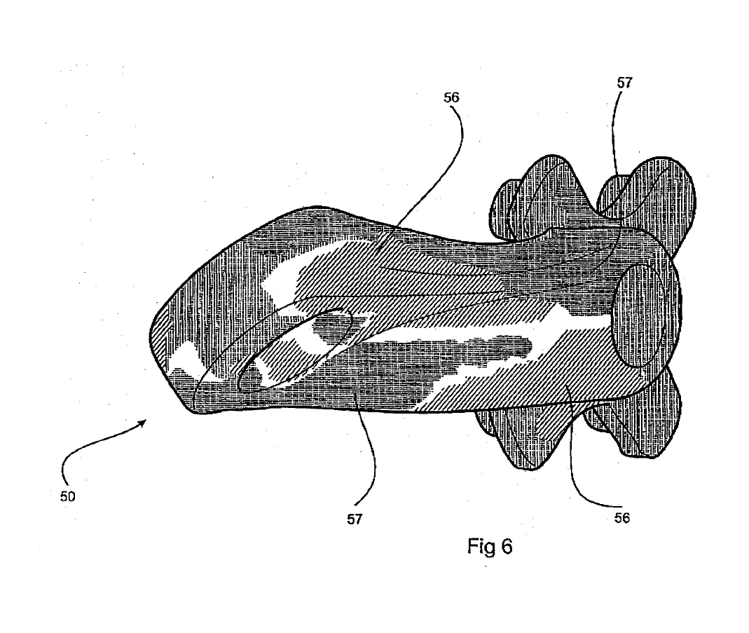

FIG. 5b shows output scans of numerical analysis of the pedal arm, 50, as shown in FIG. 5a when a torque is applied about the X axis (ie Mx as described in FIG. 4). As a result of this torque, zones of compressive, 56, and tensile, 57, strain are set up in the pedal arm that do not follow the centerline. In this depiction there are essentially two major compression-tension strain zones each with their lines of zero strain in X direction seen as between these zones. FIG. 6 provides a further view of pedal arm 50 of FIG. 5b which assists in appreciating the distribution and interface line between these zones.

The vertical dotted line, 60, (FIGS. 5a & 5b) indicates a convergence of lines of zero strain in the x-direction for the two (torque and sideways force) forces. This is towards the distal end of the pedal arm. Positioning one or more strain gauges on or about this convergence avoids inputs from those forces/torques because the compression-tension strains are zero or very small at that point or zone. However, compression-tension strains arising from effective force i.e. tangential to the arc swept by the pedal arm connected to the pedal crank, cause other compression-tension strains within the pedal arm that do not coincide with or are chosen not to coincide with this same point or zone of convergence and therefore signals relating to those effective forces can be provided to the data gathering device of the present invention and utilised to determine values for effective power, torque and/or force applied by the user.

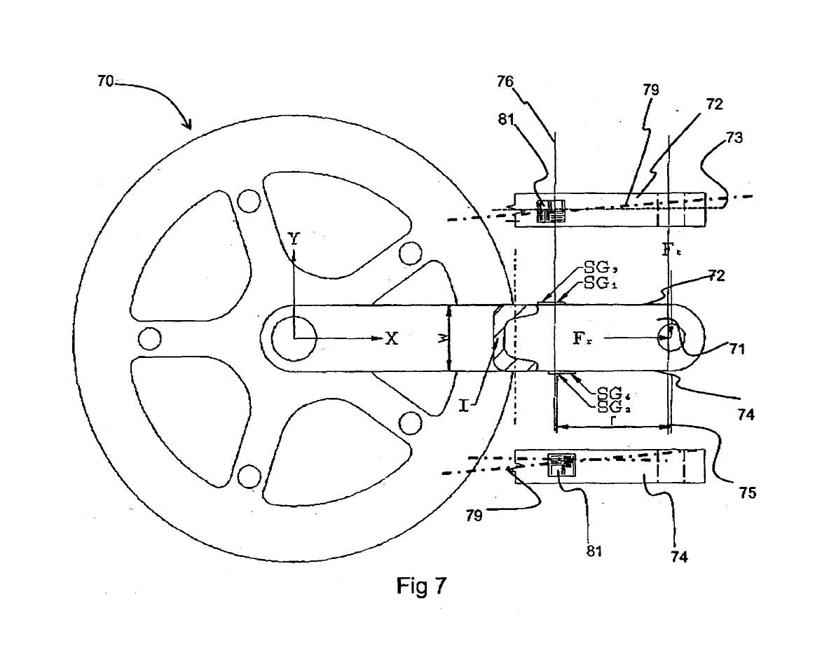

FIG. 7 shows a front view of a right hand side pedal arm assembly, 70, of a second embodiment of the present invention with the location and orientation of the strain gauges, SG1, SG2 SG3 and SG4, shown. The pedal arm 71, is generally of a “C” section shape (as shown by reference “I”. Having determined the preferred position for the strain gauges (per the point or zone of convergence mentioned above—which determine that the preferred points on opposite faces of the pedal arm may coincide or may not exactly coincide—either is considered within the scope of the present invention.) It will be noted that the longitudinal axis 79 of the strain gauges, SG1 . . . SG4, is noticeably offset from the geometric centre of the upper and lower surface (72 and 74 respectively) of the pedal (crank) arm 71 and non-parallel (skewed) to that geometric centre. The angle of skew of the strain gauges can vary depending on the required positioning of, the strain gauges determined by analysis, such as by finite element analysis (FEA). The skew angle (degree of rotation of the strain gauge relative to the centre line of the crank arm) may be relatively small but the longitudinal axis 79 of the strain gauge remains non-parallel to the crank arm centre line 73.

The strain gauge can therefore have an associated strain axis not being along or parallel to a longitudinal axis of the associated crank arm.

In FIG. 7, the strain gauges SG1 and SG2 have strain gauge axes in the X direction to measure strain in the longitudinal (or X axis) direction with respect to the crank arm are shown on opposite faces (upper face 72, and lower face 74) of the pedal arm a distance ‘r’ from the pedal axis 75 (ie they lay directly opposite each other). The strain gauges SG3 and SG4 have strain gauge axes in the Z direction to measure strain in a transverse (or Z axis) direction and therefore would not nominally have a change in electrical resistance for strains only in the X direction, are offset either side of the line 76 which is at a distance “r” from the pedal axis 75. This orientation of the strain gauges provides convenience in that the wiring tabs (not shown) on the strain gauges can both be on inner side, 81, of the arm 71 (ie on the cavity side of the “C” section on the arm 71).

The data gathering device or module etc (not shown in this view) can be mounted within the concave portion of this pedal arm. Electrical connections can then be made with the strain gauges.

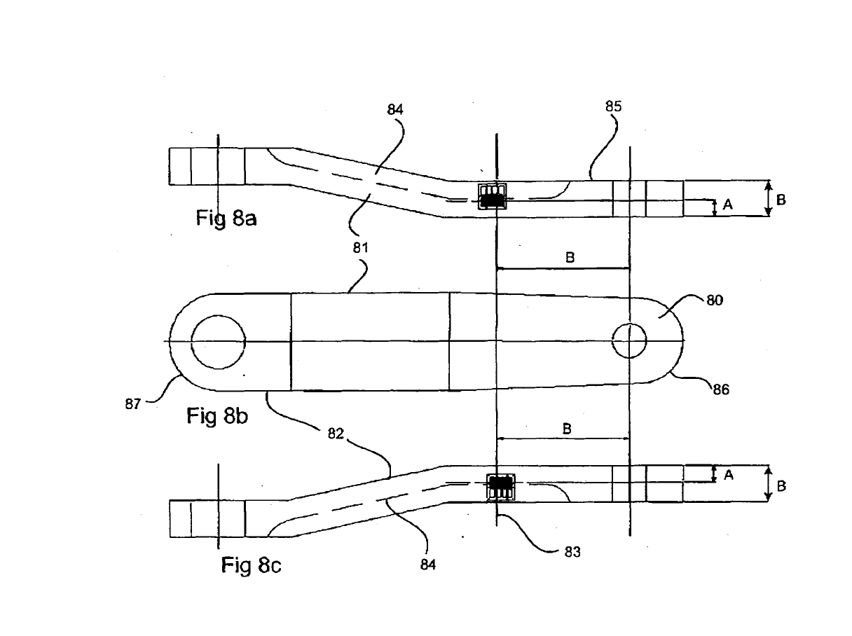

FIGS. 8a to 8c respectively show the upper face, 81, and lower face, 82, of a left hand side pedal arm, 80, of a third embodiment of the present invention with the location and orientation of the strain gauges shown, the front side view of the pedal arm of FIG. 8a and the lower face of the pedal arm of FIG. 8a. The orientation and configuration of the strain gauges is similar to that shown in FIG. 7, again noting the common axis 83 of the strain gauges laid in the X-axis direction and the offset either side of this axis 83 of the strain gauges laid orthogonal to the first mentioned strain gauges. The pedal arm 80 of this third embodiment incorporates a concavity, 84, located in the rear face 85 of the pedal arm 80. It will also be noted that the pedal arm 80 has a noticeably offset in the transverse (or Z direction) between the pedal arm end 86, and the crank axle end, 87. The present invention is applicable to such geometry. The analysis conducted by the applicant showed that the location of the strain gauges was to be located at a distance A from the front face and at a distance B from the pedal axis. Notably unlike the prior art, the distance A is not half of the width B of the pedal arm. The gauges are also not located towards the crank axle end 87 of the pedal arm as would normally be the case due to the higher strains being manifest at that location.

FIG. 9 shows a Wheatstone bridge circuit schematic applicable to embodiments of the present invention used to resolve signals from the strain gauges (SG1-SG4), such as shown in FIG. 7.

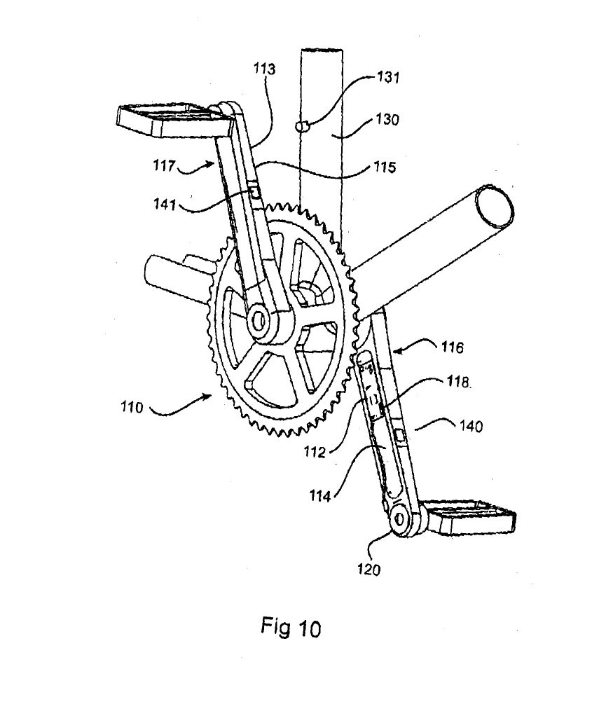

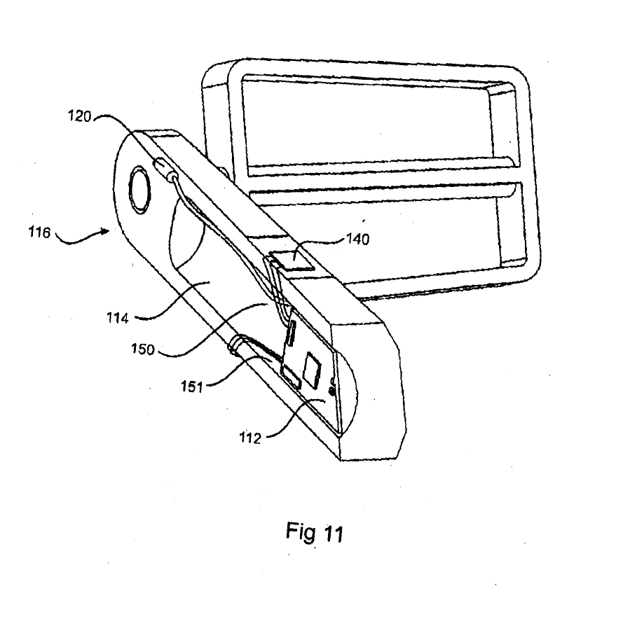

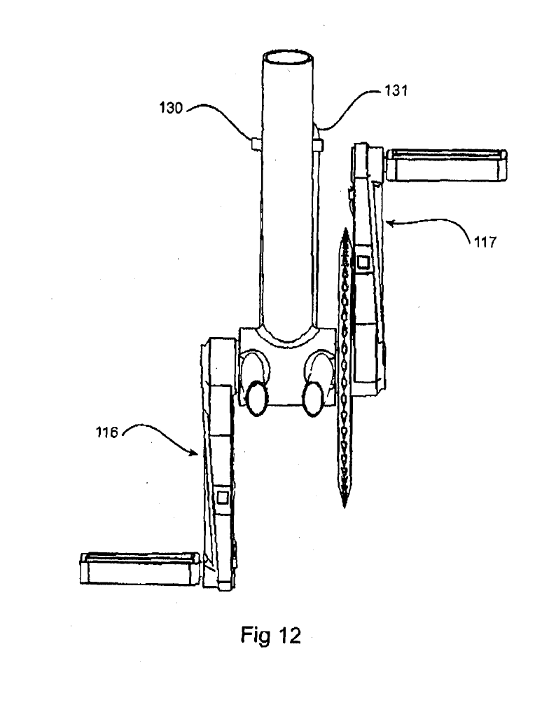

FIG. 10 shows a partial assembled view of a crank set, 110, of the first embodiment as applied to a bicycle. The device or module, 112, is mounted within a recess, 114, in the left pedal arm, 116. Similarly, a device or module 113 is mounted in a recess 115 of right pedal arm 117. The device or module can be configured such that the antenna, 118 (and a corresponding antenna 119 for the right arm 117), for communicating with a remote device (display, computer etc) is towards the distal end of the pedal arm. Cadence sensors, 120 associated with device 112 (and corresponding cadence sensor 121—not shown associated with device 113) is shown mounted adjacent the pedal axis at the distal end of the pedal arm. The cadence sensor 120 is connected to the device or module 112. The cadence sensor cooperates with a magnet 130 (shown as hidden behind the bike tube upright (magnet 131 being associated with cadence sensor 121 of the right crank 117) mounted to the bike framing and provides a signal each time the sensor 120 passes the magnet. The sensor 120 may be in the form of a known reed switch. Alternatively sensor 120 may be in the form of an electrical coil, In which case power generated in the sensor by moving through the magnetic field can be used to power the device or module and/or be used to charge a battery. Both pedal arms 116, 117 in this embodiment have strain gauges (140 and 141 of which can be seen) according to the general arrangements shown previously in FIGS. 7 and 8), indicating that there are data gathering modules in each pedal arm. Each may communicate separately with a remote device (such as display unit 16 as shown in FIG. 1) or may transfer data between themselves before both or one of them (a designated one of the two) sends data to the remote device relating to power, torque or force information from each module.

FIG. 11 shows a cross-sectioned view of the left hand crank 116 arm of the first embodiment and includes reference to identical items per FIG. 10. Connecting wires 150, 151, are shown connecting the strain gauge sets (140 of which can be seen) to the circuit board 112. The circuit board 112 is of an elongate form and is located within the rear facing cavity 114 of pedal arm 116. This affords excellent protection for the device and minimizes aerodynamic drag.

FIG. 12 shows a view from the rear of the partial assembled crank set of a first embodiment per FIG. 10.

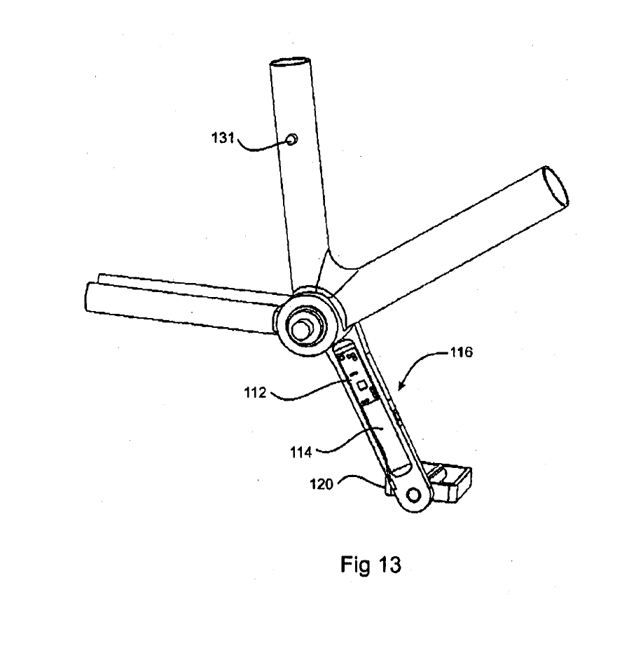

FIG. 13 shows a further view of the crank set of FIG. 10, with the right hand side crank arm and chain ring removed to show further packaging details of the power-meter device according to an embodiment of the present invention.

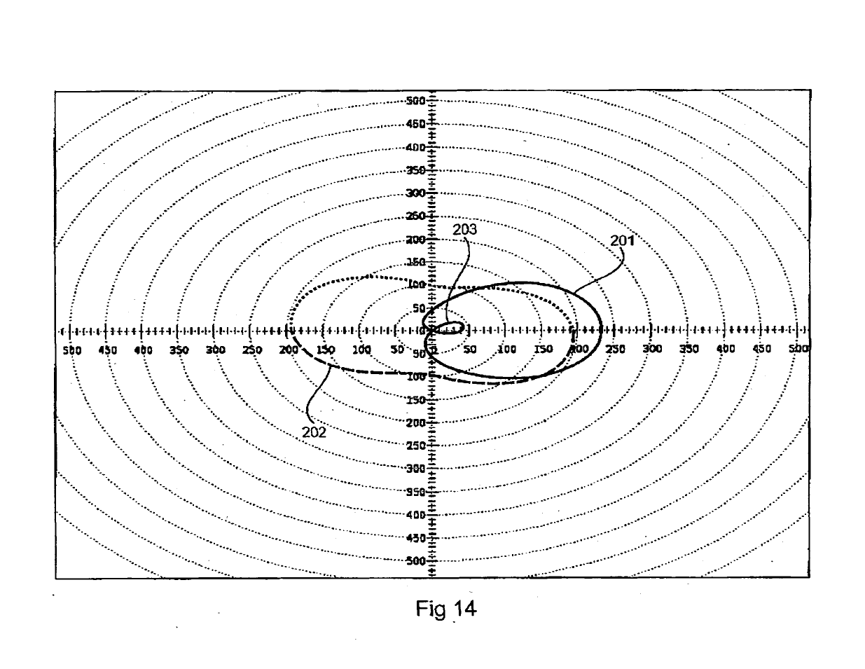

In a preferred form of the present invention the data gathering and processing devices 112 and 113 as shown in FIGS. 10 to 13, are able to output crank-angle based power data as shown in FIG. 14. FIG. 14 shows a polar plot of the power output as indicated by the data gathered from each of the left hand and right had pedal arms. The radius of the polar plot indicates the instantaneous power being generated at that crank-angle. The location of the data point on each curve represents the angular position of the pedal arm data on the x-axis of the plot represents a pedal arm in the horizontal position. Data on the lower part of the Y axis represents the pedal arm at is lowest position (or bottom dead centre) and so forth. The curve 201 represents output from the left pedal arm 116 and the curve 202 represents power output as recorded from the right pedal arm 117. The pedaling action shown in FIG. 14 has been exaggerated to show a particularly useful feature of the present invention. It will be seen by reference to plot 201 that the plot shows a maximum instantaneous power when the pedal arm 116 is in about the horizontal position (as would be expected). As the user continues to pedal, the plot approaches the zero point of the radar chart and then produces a small loop 203. This loop represents “negative” power in the sense that the users leg was “dragging” on the pedal arm 116 and in effect being pushed upwards by the opposite pedal arm 116. In contrast, plot 202 shows that power was being produced for the entire 360 degree cycle. This may be achieve by the user pulling up on the pedal arm 117 during the upstroke.

The data to generate and display the plots shown in FIG. 14 (or derivatives or variations of such plots—for example processing of the data could conveniently indicate a “balance” factor being the difference of the power being produced by the left leg or right leg of a bike rider and this could be indicated as a bar which moves left or right depending on where the balance may be) is conveniently provided by the data acquisition processing devices 112 and 113 shown in FIGS. 10 to 13, by taking a number of sample data from the strain gauges as the respective pedal arm travel through a rotation, applying a fast Fourier transformation (FFT) of such data and transmitting a required number of terms of such FFT to a display device. The first term of the FFT may be the average power for a single rotation of the pedal arms. This first term may be useful for displays that may only be able to receive and display an average power. However, the other terms of the FFT may be useful for other display devices which are capable of display plots similar to FIG. 14, or other variations or derivatives as discussed above.

As strain gauges are known to be relatively high consumers of electrical current when operating, the data acquisition and communications device of the present invention may be operated in a way such that the strain gauges are only activated at those times that data is required to be sampled for the purposes of FFT processing. In such a case a microprocessor may set a clock based on a recorded period of one compete crank cycle (eg by sensing 2 consecutive cadence inputs), divide that time into a number of equal periods suitable for input to and FFT process (samples of 2 to the power of “n” where “n” is a whole number are convenient—the applicant having chose 64 samples in the embodiment shown in FIG. 14) and then control an A-D converter in such a way that the A-D converter turns the strain gauges on at each of the 64 increments, samples the reading of the strain gauges, processes the A-D conversion, passes the data on to a main microprocessor for FFT processing and then turns itself off awaiting the next of the set timing events for sampling the strain gauges.

Additional processing strategies may be used to take account of reduced or increased cadence rates during a sampling period. For example if the cadence rate reduces, the present number of samples (in the above example, 64) will have been completed before a cadence signal is received, Conversely, if the cadence rate of the user has increased during the time that the sampling is being conducted, a cadence signal will be received prior to the complete sampling data set has been taken (eg only 60 of the 64 samples may have been taken as the cadence rate increased).

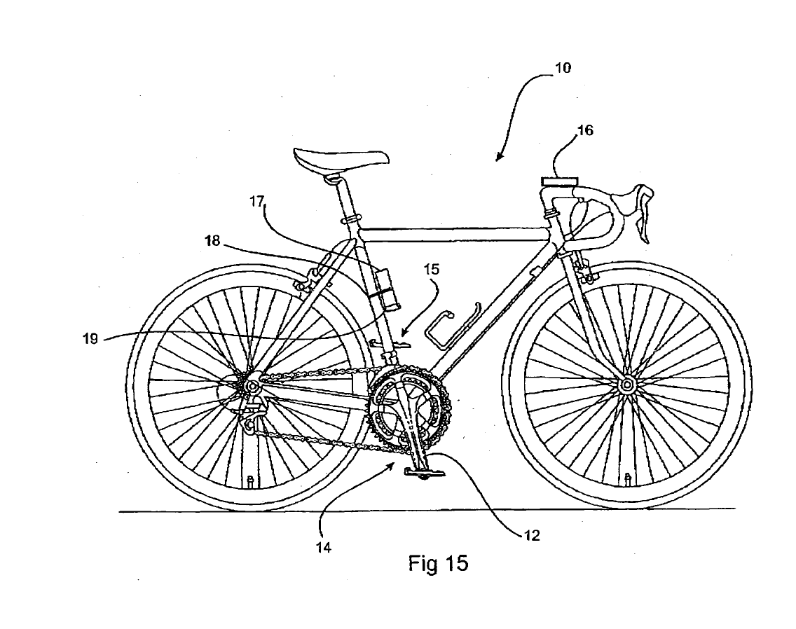

FIG. 15 shows the bicycle 10 previously described in relation to FIG. 1. The bicycle includes a data logger 17 mounted to an upright of the frame. The data logger 17 has a waterproof body with a releasable closure 19 (not shown) at a lower end thereof. This closure may be a screw or bayonet fit cap or cover, preferably including an o-ring type seal to prevent ingress of water or dirt. The closure may be provided at the lower end of the data logger when mounted in position such that water cannot run down into an otherwise, open end if the data logger was the other way up. The data logger can be removable for connection to a computer or related docking station, or for recharging or changing of batteries, or swapping for another data logger if need be. Alternatively, the data logger can be permanently or semi-permanently attached to the frame i.e. the intention being that the data logger is not normally removed. A portable memory device or data logger reader can be connected to electrical connections behind the closure. In use, the closure is removed and the portable memory device or reader is connected. Data is transferred out of the data logger. The data logger may then be reset or reused with or without the original data remaining stored.

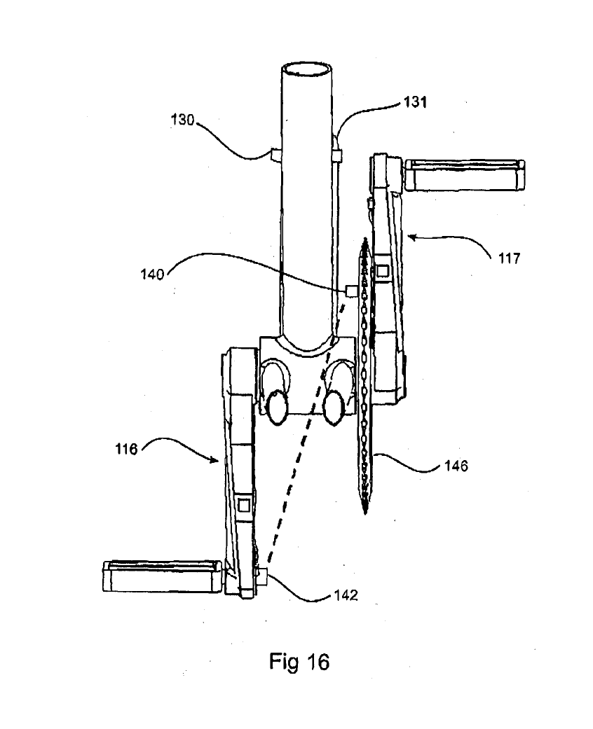

As shown in FIG. 16, an antenna 160 of one cyclic cranked system data gathering device may be mounted to a crank arm 117 within the radius of the chain wheel (chain ring) 146 of a bicycle. The associated cyclic cranked system data gathering device is mounted in a recess/cavity in the body of right hand crank arm 117 and has an associated strain gauge arrangement 140 mounted to a face external to the crank arm 117 and intermediate the crank axle and pedal, in this embodiment, the antenna 160 is mounted on an inner face of the right hand crank arm 117 i.e. facing the chain ring 146, and preferably corresponding to an aperture through the shape of chain ring 146 to give improved line of sight communication with the second antenna 162 The second antenna 162 is mounted towards a distal end of the left hand crank arm 116. With such asymmetrical positioning of the antennae i.e. at unequal distances along each crank arm from the axle, it will be appreciated that line of sight between the two antennae is improved over having the antennae at equal distances along each respective crank arm from the crank axis. With line of sight happening more often during a given single rotation of the crankset, reliability of data transfer is improved.

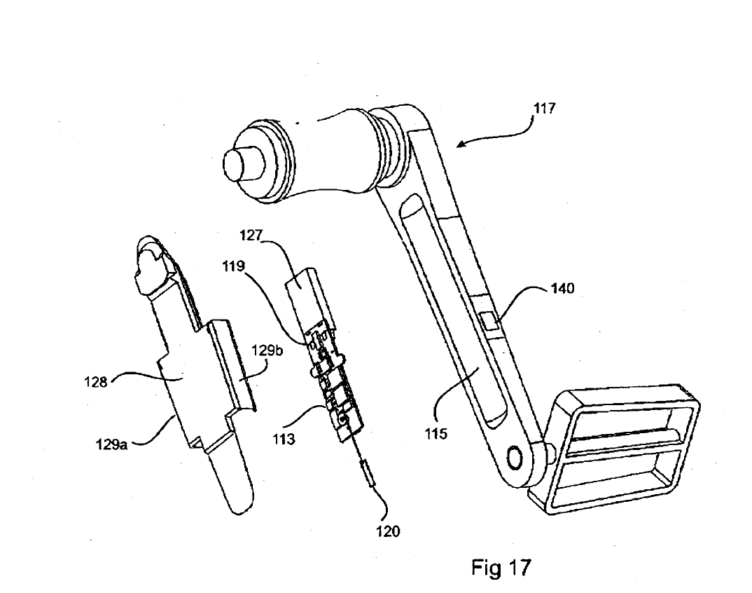

FIG. 17 shows an exploded view of a right hand crank set assembly of a further embodiment which is similar to, that shown in FIG. 10 and reference numbers shall correspond to those in FIG. 10 for similar parts. The device or module, 113, is mounted within a recess, 115, in the right pedal arm, 117. The device or module can be configured such that the antenna, 119 (and a corresponding antenna 119, for communicating with a remote device (display, computer etc) and/or a corresponding left crank arm (not shown) is towards the proximal end of the pedal arm. Cadence sensors, 121 associated with device 117 (and corresponding cadence sensor 121—not shown associated with device 113) is shown mounted adjacent the pedal axis at the distal end of the pedal arm. The cadence sensor 120 is connected to the device or module 113. The sensor 120 may be in the form of a known reed switch. Alternatively sensor 120 may be in the form of an electrical coil, in which case electrical power generated in the sensor by moving through the magnetic field can be used to power the device or module and/or be used to charge a battery, 127. The entire data acquisition and processing package comprising of the circuit board module 113, cadence sensor 120, battery 127 and strain gauges 140 may be housed beneath a protective housing 128. The protective housing has regions 129a and 129b in the form of extensions that cover the region of the strain gauges. During the manufacturing process a waterproofing coating (for example silicone) may be applied so as to encase the data acquisition or processing system before the housing 128 is put into position. The housing 129 may be held to the crank arm by any number of means including adhering or bonding (such as gluing), by fasteners, or by resilient “snap fit” into position by providing suitable resilient flexibility to the housing and having it at least partially wrap around the crank arm 117.

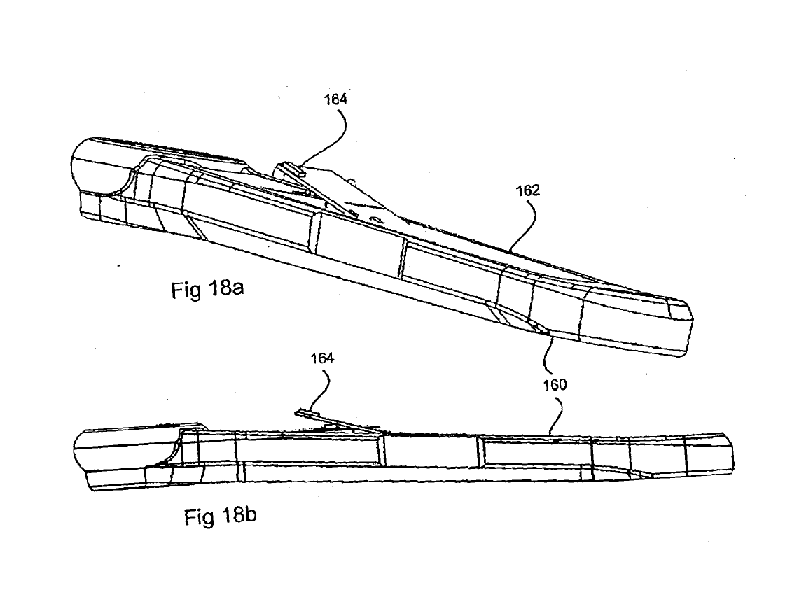

FIGS. 18A and 18B show alternative configurations of the data gathering device 162 set into a recess in a crank arm 160 and with an antenna 164 for sending and receiving data signals exposed outside of an envelope of the crank arm. This arrangement ensures that the antenna is clear of the material of the crank arm and therefore reduces risk of signal loss between data gathering devices and/or with other devices, such as a remote data logger, display or computer (particularly if the crank arm is of a metallic material).

In understanding the scope of the present invention, the term “configured” and its derivatives as used herein to describe a component, section or part of a device includes hardware and/or software that is constructed and/or programmed to carry out the desired function. In understanding the scope of the present invention, the term “comprising” and its derivatives, as used herein are intended to be open ended terms that specify the presence of the stated features, elements, components, groups integers, and/or steps, but do not exclude the presence of other unstated features, elements, components, groups, integers and/or steps. The foregoing also applies to words having similar meanings such as the terms, “including”, “having” and their derivatives. Also, the terms “part”, “section”, “portion”, “member” or “element” when used in the singular can have the dual meaning of a single part or a plurality of parts. As used herein to describe the present invention, the following directional terms “forward, rearward, above, downward, vertical, horizontal, below, longitudinal and transverse” as well as any similar directional terms refer to those directions of a bicycle equipped with the present invention. Accordingly, these terms should be interpreted relative to a cycle equipped with the present invention as used in the normal riding position. Finally, terms of degree such as “substantially”, “about” and “approximately” as used herein mean a reasonable amount of deviation of the modified term such that the end result is not significantly changed.

Although a number of embodiments have been described it will be appreciated that the invention is not only applicable to leg powered bicycles and is not necessarily limited to leg powered devices as has been exemplified in the description.

For example, and without limiting the scope of the invention, there are leg powered vehicles appearing on the market wherein the rider “steps” on a reciprocating platform provided for each leg. The motion of the reciprocating platform is translated, via various mechanisms, to drive one or more wheels of what is otherwise similar to a bicycle. Each of the reciprocating platforms is pivoted such that the platform moves in a partial arc fashion during reciprocation. The present invention may be readily adapted to provide power, force, torque cadence and other information in respect to the effort provided by the rider in powering the vehicle.

Other modifications and variations of the invention may be apparent to skilled readers of this disclosure. Such modifications and variations are deemed within the scope of the present invention.

1. A cyclic cranked system data gathering system having at least one crank arm operable by a limb of a user, the system including at least one data gathering device, each said data gathering device mounted to a respective said crank arm and having or connected to a respective sensor, said at least one device configured to obtain data relating to force applied by the user through the respective crank arm and sensed by the sensor, the or each data gathering device having a data transmitter capable of sending said data to a remote data logger, remote computer or to a display device.

2. A cyclic cranked system data gathering system according to claim 1, including a said data gathering device mounted to one of the said at least one crank arm, the data gathering device configured to obtain data relating to force applied by the user through that crank arm.

3. A cyclic cranked system data gathering system according to claim 1, the system including first and second crank arms connected to operate in a coupled cyclic manner, with each crank arm configured to be operated by a respective limb of a user.

4. A cyclic cranked system data gathering system according to claim 3, including a first data gathering device mounted to the first crank arm and a second data gathering device mounted to the second crank arm, each said first and second device configured to obtain data relating to force applied by the limb of the user operating on the respective crank arm.

5. A cyclic cranked system data gathering system according to claim 4, wherein the first device mounted to the first crank arm is configured to transmit force related data to the second device on the second crank arm.

6. A cyclic cranked system data gathering system according to claim 5, wherein said first and second devices are configured to transmit data relating to force applied by the user through their respective crank arm to the other of said second and first devices.

7. A cyclic cranked system data gathering system according to claim 3, wherein at least one of said first and second devices includes a transmitter configured to send force related data to the remote data logger, remote computer or to the display.

8. A cyclic cranked system data gathering system according to claim 7, wherein each of the first and second devices has or is connected to a respective said transmitter such that each device is configured to send force related data to the remote data logger, remote computer or to the display.

9. A cyclic cranked system data gathering system as claimed in claim 1, wherein each data gathering device has or is connected to at least one associated said sensor.

10. A system as claimed in claim 9, wherein the at least one associated said sensor includes a strain gauge mounted to the respective crank arm.

11. A cyclic cranked system data gathering system as claimed in claim 9, wherein the sensor mounted to each respective crank arm are mounted at asymmetrical distances from a crank spindle with respect to each other.

12. A cyclic cranked system data gathering system as claimed in claim 11, the system applied to a cycle, wherein the sensor of the second crank arm of a chain ring side of a cycle crank set is mounted to the second crank arm within the radius of the chain ring from the crank spindle axis connecting the crank arms, and the sensor of the first crank arm is mounted at a distance from the crank spindle axis greater than the radius of the chain ring associated with the first crank arm.

13. A cyclic cranked system data gathering system as claimed in claim 1 including a data logger to record rider power, force and/or torque related data derived by the said device(s).

14. A cyclic cranked system data gathering system as claimed in claim 1, including audible and/or visual warning means arranged to indicate to the user one or more of a required system parameter, characteristic of the user force related data parameter or value or combinations thereof.

15. A system as claimed in claim 1, including audible and/or visual warning means arranged to activate if an inductive charger used to recharge a battery of one or more of said devices is left mounted in position.

16. A data gathering system of a cyclic cranked system, including at least one data gathering device mounted to a crank arm of a crank operated apparatus, the at least one data gathering device including a receiver to receive data signals and a transmitter to output data signals from the respective device to a display or other remote device or receiver.

17. A system as claimed in claim 16, each said data gathering device further including a receiver to input signals to the device, and each device including a transmitter to output signals from the respective device, one of the first or second devices arranged to receive signals from the other of said devices and transmit signals to a display or other receiver relating to a combination of signals from the first and second devices.

18. A system as claimed in claim 16, each of the first and second devices including an antenna for transmitting data, each transmitter offset respective crank arm relative to the transmitter of the other device.

19. A system as claimed in claim 18, wherein the antenna of the first or second device is positioned on or in the right hand crank arm is closer to the axle of the crankset compared to the other of the first and second devices on or in the left hand crank arm and at a smaller radius from the crank axis than a maximum radius of a corresponding chain-ring.

20. A system according to claim 19, wherein the antenna associated with the crank arm attached to the chain rings is inside the radius of the smallest radius chain ring

21. A system as claimed in claim 16, including data signal transmission means arranged to transmit data signals through the crank axis.

22. A system as claimed in claim 21, wherein the crank is hollow and the data transmission means is a wireless means arranged to transmit data signals between the first and second devices, each device on a respective crank arm, wirelessly through the hollow crank.

23. A system as claimed in claim 1, wherein the sensor includes one or more strain gauges mounted on the respective crank arm, and a signal or data processor and data transmission means mounted in the device on or within a cavity of the respective crank arm.

24. A system as claimed in claim 1, wherein the position of the sensor on a corresponding crank arm is determined by finite element analysis.

25. A system as claimed in claim 24, wherein the FEA simulates strain actually measured by the sensor(s) each mounted in a selected location on the crank-arm, such location resulting in a zero output from a data processor for all forces and torques applied by a user to the crank arm except those forces which result in a mechanical power input to the rotating crank.

26. A system as claimed in claim 23, including the strain gauge(s) positioned on a crank-arm that is asymmetrical in cross-section.

27. A system as claimed in claim 1, wherein the sensor includes at least one strain gauge, the at least one strain gauge having an associated strain axis not being along or parallel to a longitudinal axis of the associated crank arm.

28. A system as claimed in claim 23, including the strain gauge(s) positioned on a crank-arm that is not of a constant cross-section along its length.

29. A system as claimed in claim 1, the sensor on a crank arm including multiple strain gauges arranged orthogonal to each other.

30. A system as claimed in claim 1, at least one said device including a processor to process the force related data obtained by the respective device prior to sending the processed data to another said device, a display, a remote data logger or remote computer.

31. A system as claimed in claim 30, wherein Fast Fourier Transform (FFT) processing is carried out on the force related data by the processor.

32. A system as claimed in claim 1, including at least one data logger to store data signals from one or more of the cyclic cranked system data gathering devices.

33. A system as claimed in claim 32, wherein the data logger is configured to store signals preprocessed by one or more of the data gathering devices, unprocessed, or processed by a processor within the data logger.

34. A system as claimed in claim 32, the data logger including a capsule or container housing a data memory device.

35. A system as claimed in claim 32, the data logger including connection means to electrically or optically connect to a remote data memory device.

36. A system as claimed in claim 32, including a removable cover protecting, when in place, a physical connection to the data logger for electrical transfer of data.

37. A system as claimed in claim 36, the removable cover including a screw or bayonet cap to protect an electrical connection point.

38. A system as claimed in claim 36, the data logger including water resistant or waterproofing means to releasably seal the cover.

39. A system as claimed in claim 32, the data logger provided as a discrete unit mountable via mounting means to a frame or other portion of a cycle or built into tubing of a frame of the cycle.

40. A system as claimed in claim 32, wherein the data logger includes a sealed unit with integral power supply or rechargeable power supply charged from the cyclic cranked system data gathering device from a device to which it is connected during data retrieval.

41. A system as claimed in claim 32, the data logger including memory means configured to store raw data from the cyclic cranked system data gathering device(s) for subsequent retrieval.

42. A system as claimed in claim 1, including one or more cycle rider audible and/or vibration indication devices configured to operate when certain thresholds or limits are met.

43. A system as claimed in claim 42, wherein the indication device(s) include attachment means configured to attach to the rider or rider's clothing.

44. A system as claimed in claim 42, the indication device(s) being part of a headset or other headgear, an earpiece, or having a transducer to provide vibration indications to the rider's skin.

45. A system as claimed in claim 1, the cyclic cranked system data gathering device including a hermetic seal provided by a coating or covering over the respective device on or in the associated crank arm.

46. A system as claimed in claim 45, the hermetic seal including a polymeric material protective layer over the device.

47. A system as claimed in claim 45, the coating or covering including a pre-formed or pre-moulded protector or a plastic coating applied over the device on or in the crank arm.

48. A system as claimed in claim 45, including a crank arm provided with the cyclic cranked system data gathering device ready mounted to a surface or within a recess of the crank arm, and the device hermetically sealed to the crank arm against ingress of dirt and water.

49. A system as claimed in claim 1, the system being a power meter system arranged to processes strain signals received from one or more strain gauges mounted on the respective crank arm(s) and to determine from those signals force applied by a user through the crank arm(s) and therefrom determine power applied by the user.

50. A method of determining power applied to a cyclic cranked system, the method including;
a) using a device mounted on a crank arm of the cranked system to sense strain signals resulting from force applied to one or more crank arms by a user;
b) determining power applied by the user from the strain data;
c) transmitting the strain data, modified or unmodified, to one or more of a display, a data logger, a computer or another similar device mounted on another crank arm of the cranked system.

51. A method according to claim 50, further including detecting if data has not been received from one of the devices, and if such data has not been received, sending a modified data set to an external data logger, computer and/or display unit.

52. A method according to claim 51, including doubling or repeating the value or amount of data determined by the device in order to compensate for the missing data from the other device, and sending the resulting compensated data to the data logger, computer and/or display unit.

53. A method according to claim 50 including the device(s) taking one or more sample readings using the sensors, the one or more sample readings relating to effort exerted by the user, processing this data obtained, and sending data values to a data logger, computer and/or display unit or head-unit.

54. A method according to claim 53, including using fast fourier transformation in the processing.
